(19) United States
(12) Patent Application Publication
(10) Pub. No.: US 2025/0005086 A1
(43) Pub. Date: Jan. 2, 2025

(54) GENERATING RESPONSES TO SEARCH QUERIES BASED ON CONTEXT OF USERS ASSOCIATED WITH THE SEARCH QUERIES

(71) Applicant: Dell Products L.P., Round Rock, TX (US)

(72) Inventors: Vivek Bhargava, Bangalore (IN); Abhishek Mishra, Bangalore (IN); Vaideeswaran Ganesan, Bengaluru (IN); Rishav Sethia, Bangalore (IN)

(21) Appl. No.: 18/342,887

(22) Filed: Jun. 28, 2023

(51) Int. Cl. G06F 16/9535; G06F 16/9532; G06F 16/954; G06F 40/40

(52) U.S. Cl. CPC G06F 16/9535; G06F 16/9532; G06F 16/954; G06F 40/40

(57) ABSTRACT

An apparatus comprises a processing device configured to receive a search query associated with a given user, to determine a user context specifying topics of interest and a level of detail sought by the given user, and to execute the search query to obtain search results. The processing device is also configured to apply natural language processing to the search results to assign classifications from a set defined based at least in part on the topics of interest of the given user. The processing device is further configured to utilize machine learning to filter the search results for relevancy based at least in part on the classifications assigned to the search results. The processing device is further configured to generate and provide to the given user a search response to the search query in a format selected based on the level of detail sought by the given user.

### FIELD

The field relates generally to information processing, and more particularly to techniques for managing data.

### BACKGROUND

In many information processing systems, data stored electronically is in an unstructured format, with documents comprising a large portion of unstructured data. Collection and analysis, however, may be limited to highly structured data, as unstructured text data requires special treatment. For example, unstructured text data may require manual screening in which a corpus of unstructured text data is reviewed and sampled. Alternatively, the unstructured text data may require manual customization and maintenance of a large set of rules that can be used to determine correspondence with predefined themes of interest. Such processing is unduly tedious and time-consuming, particularly for large volumes of unstructured text data.

### SUMMARY

Illustrative embodiments of the present disclosure provide techniques for generating responses to search queries based on context of users associated with the search queries.

In one embodiment, an apparatus comprises at least one processing device comprising a processor coupled to a memory. The at least one processing device is configured to receive a search query associated with a given user, to determine a user context associated with the given user, the user context specifying (i) one or more topics of interest of the given user and (ii) a level of detail sought by the given user, and to execute the search query to obtain one or more search results. The at least one processing device is also configured to apply natural language processing to the one or more search results to assign, to each of the one or more search results, at least one classification of a set of two or more classifications, the set of two or more classifications being defined based at least in part on the one or more topics of interest specified in the determined user context. The at least one processing device is further configured to utilize one or more machine learning models to filter the one or more search results for relevancy to the given user, the relevancy being determined based at least in part on the classifications assigned to each of the one or more search results. The at least one processing device is further configured to generate a search response to the search query based at least in part on the filtering and in a format selected based at least in part on the level of detail specified in the determined user context, and to provide the generated search response to the given user in the selected format.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for generating responses to search queries based on context of users associated with the search queries in an illustrative embodiment.

FIG. 2 is a flow diagram of an exemplary process for generating responses to search queries based on context of users associated with the search queries in an illustrative embodiment.

FIG. 3 shows a process flow for generating responses to search queries based on context of users associated with the search queries in an illustrative embodiment.

FIG. 4 show a system configured for generating responses to search queries based on context of users associated with the search queries in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

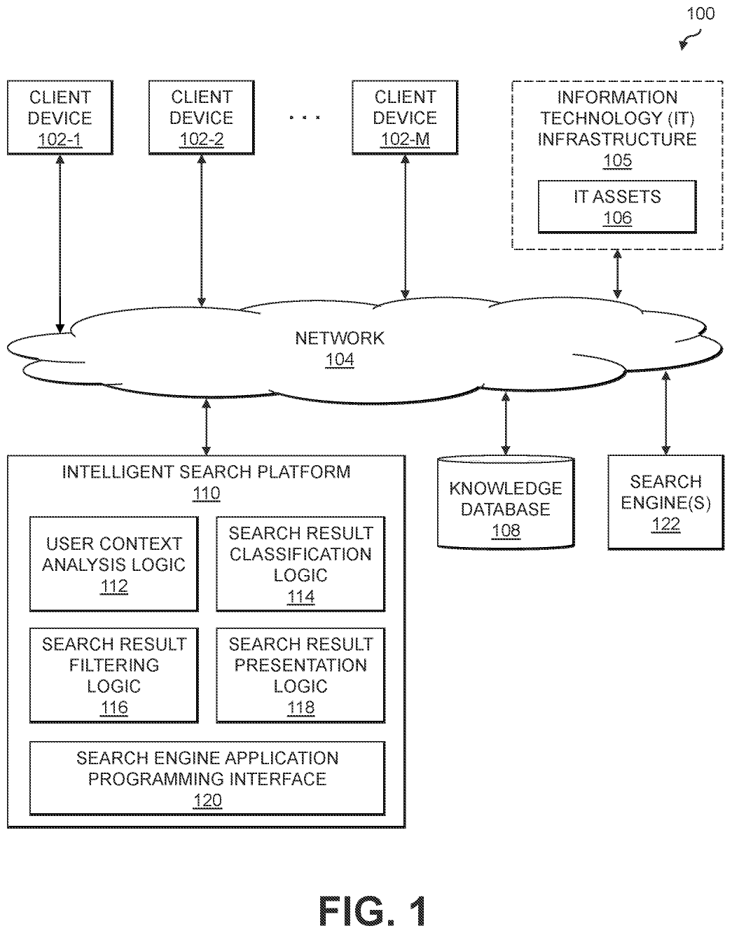

FIG. 1 shows an information processing system 100 configured in accordance with an illustrative embodiment. The information processing system 100 is assumed to be built on at least one processing platform and provides functionality for generating responses to search queries based on context of users associated with the search queries. The information processing system 100 includes a set of client devices 102-1, 102-2, . . . 102-M (collectively, client devices 102) which are coupled to a network 104. Also coupled to the network 104 is an information technology (IT) infrastructure 105 comprising one or more IT assets 106, a knowledge database 108, and an intelligent search platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the intelligent search platform 110 is used by or for an enterprise system. For example, an enterprise may subscribe to or otherwise utilize the intelligent search platform 110 for enabling users (e.g., of client devices 102) to perform searches (e.g., of content that is stored on or otherwise associated with the IT assets 106 in the IT infrastructure 105). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities). In other embodiments, the intelligent search platform 110 may be operated by an enterprise that is a hardware or software vendor of assets (e.g., IT assets 106 in the IT infrastructure 105, the client devices 102). For example, one or more users of the client devices 102 may be associated with developers or support teams of an enterprise, with the intelligent search platform 110 being utilized by such users to search for content to aid in development or providing support for the IT assets 106. As another example, one or more users of the client devices 102 may be associated with sales representatives of an enterprise, with the intelligent search platform 110 being utilized by such users to search for content to aid in presenting relevant content to potential customers interested in the IT assets 106 of the IT infrastructure. Various other examples are possible.

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The knowledge database 108 is configured to store and record various information that is utilized by the intelligent search platform 110. Such information may include, for example, user context and profile information, categories or topic information, natural language processing (NLP) algorithms, machine learning classification algorithms, search results, filtering rules, etc. In some embodiments, one or more storage systems utilized to implement the knowledge database 108 comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the intelligent search platform 110, as well as to support communication between the intelligent search platform 110 and other related systems and devices not explicitly shown.

In some embodiments, the client devices 102 are assumed to be associated with system administrators, IT managers or other authorized personnel responsible for managing the IT assets 106 of the IT infrastructure 105. For example, a given one of the client devices 102 may be operated by a user to access a graphical user interface (GUI) provided by the intelligent search platform 110 to perform searches related to one or more of the IT assets 106 of the IT infrastructure 105. The intelligent search platform 110 may be provided as a cloud service that is accessible by the given client device 102 to allow the user thereof to perform searches related to one or more of the IT assets 106 of the IT infrastructure 105 (e.g., for use in developing or providing support for one or more of the IT assets 106, for facilitating sales or other management of one or more of the IT assets 106, etc.). In some embodiments, the IT assets 106 of the IT infrastructure 105 are owned or operated by the same enterprise that operates the intelligent search platform 110 (e.g., where an enterprise such as a business provides support for the assets it operates). In other embodiments, the IT assets 106 of the IT infrastructure 105 may be owned or operated by one or more enterprises different than the enterprise which operates the intelligent search platform 110 (e.g., a first enterprise provides support for assets that are owned by multiple different customers, business, etc.). Various other examples are possible.

In some embodiments, the client devices 102 and/or the IT assets 106 of the IT infrastructure 105 may implement host agents that are configured for automated transmission of information regarding search queries, user context, etc., which may be used by the intelligent search platform 110 for providing relevant search results for such search queries. The host agents may also be configured to receive, from the intelligent search platform 110, notifications regarding relevant search results for search queries. It should be noted that a “host agent” as this term is generally used herein may comprise an automated entity, such as a software entity running on a processing device. Accordingly, a host agent need not be a human entity.

The intelligent search platform 110 in the FIG. 1 embodiment is assumed to be implemented using at least one processing device. Each such processing device generally comprises at least one processor and an associated memory, and implements one or more functional modules or logic for controlling certain features of the intelligent search platform 110. In the FIG. 1 embodiment, the intelligent search platform 110 implements user context analysis logic 112, search result classification logic 114, search result filtering logic 116 and search result presentation logic 118. The user context analysis logic 112 is configured to analyze a search query received from one or more of the client devices 102 to understand a context and intent of the user submitting that search query. The intelligent search platform 110 utilizes a search engine application programming interface (API) 120 in order to submit the search query to one or more search engines 122, which returns results back to the intelligent search platform 110. The search result classification logic 114 is configured to classify the search results based on the user context determined utilizing the user context analysis logic 112. The search result classification logic 114 may apply one or more natural language processing (NLP) techniques. The search result filtering logic 116 is configured to filter the search results for relevance based at least in part on the classifications determined utilizing the search result classification logic 114. The search result filtering logic 116 may utilize one or more machine learning algorithms for filtering the search results. The search result presentation logic 118 is configured to present the filtered search results to the user (e.g., via a GUI). The search result presentation logic 118 may be configured to determine a desired format for presenting the filtered search results, where the desired format may be based on the user context, preferences of the user, etc.

At least portions of the user context analysis logic 112, the search result classification logic 114, the search result filtering logic 116 and the search result presentation logic 118 may be implemented at least in part in the form of software that is stored in memory and executed by a processor.

The intelligent search platform 110 and other portions of the information processing system 100, as will be described in further detail below, may be part of cloud infrastructure.

The intelligent search platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, the IT infrastructure 105, the knowledge database 108 and the intelligent search platform 110 or components thereof (e.g., the IT assets 106, the user context analysis logic 112, the search result classification logic 114, the search result filtering logic 116 and the search result presentation logic 118) may be implemented on respective distinct processing platforms, although numerous other arrangements are possible. For example, in some embodiments at least portions of the intelligent search platform 110 and one or more of the client devices 102, the IT infrastructure 105 and/or the knowledge database 108 are implemented on the same processing platform. A given client device (e.g., 102-1) can therefore be implemented at least in part within at least one processing platform that implements at least a portion of the intelligent search platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, the IT assets 106, the knowledge database 108 and the intelligent search platform 110, or portions or components thereof, to reside in different data centers. Numerous other distributed implementations are possible. The intelligent search platform 110 can also be implemented in a distributed manner across multiple data centers.

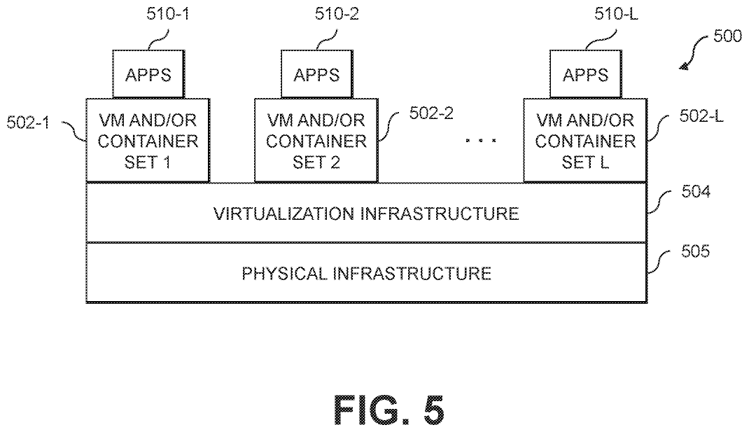

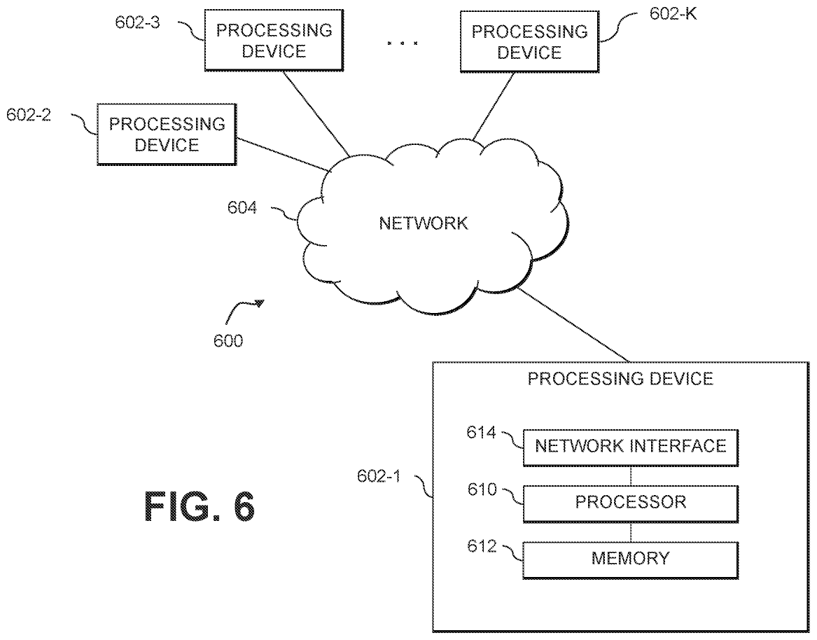

Additional examples of processing platforms utilized to implement the intelligent search platform 110 and other components of the information processing system 100 in illustrative embodiments will be described in more detail below in conjunction with FIGS. 5 and 6.

It is to be appreciated that these and other features of illustrative embodiments are presented by way of example only, and should not be construed as limiting in any way.

It is to be understood that the particular set of elements shown in FIG. 1 for generating responses to search queries based on context of users associated with the search queries is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

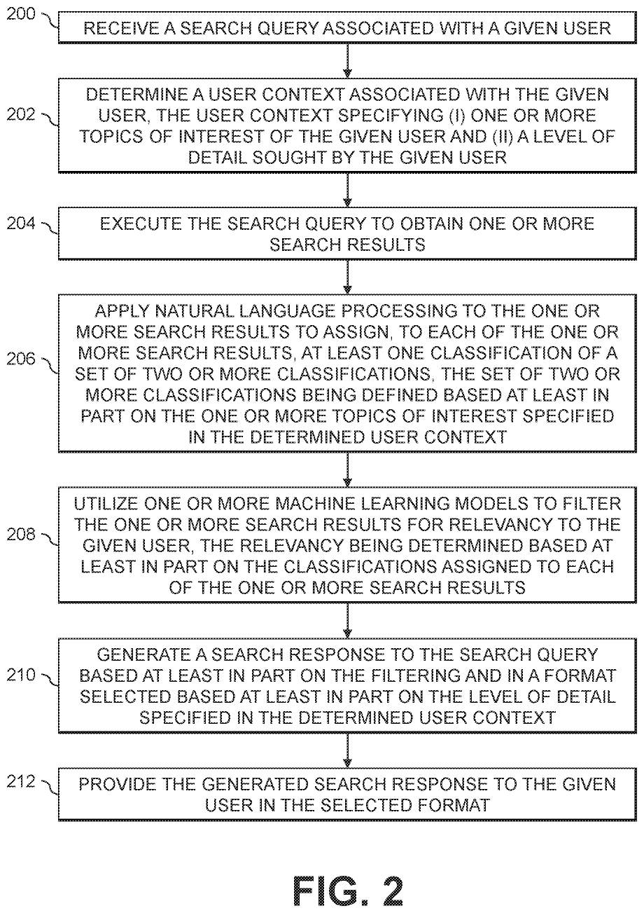

An exemplary process for generating responses to search queries based on context of users associated with the search queries will now be described in more detail with reference to the flow diagram of FIG. 2. It is to be understood that this particular process is only an example, and that additional or alternative processes for generating responses to search queries based on context of users associated with the search queries may be used in other embodiments.

In this embodiment, the process includes steps 200 through 212. These steps are assumed to be performed by the intelligent search platform 110 utilizing the user context analysis logic 112. the search result classification logic 114, the search result filtering logic 116 and the search result presentation logic 118. The process begins with step 200, receiving a search query associated with a given user. In step 202, a user context associated with the given user is determined. The user context specifies (i) one or more topics of interest of the given user and (ii) a level of detail sought by the given user. Step 202 may include identifying the one or more topics of interest of the given user based at least in part on a user profile of the given user, where the user profile of the given user specifies at least one of demographic information associated with the given user, a location of the given user, and a search history of the given user. Step 202 may also or alternatively include identifying the one or more topics of interest of the given user based at least in part on user behavior of the given user, where the user behavior of the given user is determined based at least in part on analyzing interaction of the given user with at least one user interface at which the search query is received and the search response is provided. Step 202 may further or alternatively include identifying the one or more topics of interest of the given user based at least in part on applying natural language processing to text of the search query, the natural language processing comprising analyzing syntax, semantics and context of the text of the search query. In some embodiments, determining the user context in step 202 is based at least in part on identifying a role of the given user within an enterprise and/or identifying an inclination of the given user, where the inclination of the given user is determined based at least in part on one or more types of content consumed by the given user. Determining the user context in step 202 may be based at least in part on recency of activity of the given user. In some embodiments, the given user comprises a target customer of an enterprise, and the user context is determined based at least in part on past interactions between the target customer and the enterprise.

The FIG. 2 process continues with step 204, executing the search query to obtain one or more search results. In step 206, natural language processing is applied to the one or more search results to assign, to each of the one or more search results, at least one classification of a set of two or more classifications. The set of two or more classifications is defined based at least in part on the one or more topics of interest specified in the determined user context. Step 206 may include identifying one or more keywords in the one or more search results, and mapping the identified one or more keywords to respective ones of the classifications in the set of two or more classifications.

In step 208, one or more machine learning models are utilized to filter the one or more search results for relevancy to the given user, the relevancy being determined based at least in part on the classifications assigned to each of the one or more search results in step 206. Step 208 may include generating, utilizing the one or more machine learning models, relevancy scores for the one or more search results. A search response to the search query is generated in step 210 based at least in part on the filtering and in a format selected based at least in part on the level of detail specified in the determined user context. The generated search response is provided to the given user in the selected format in step 212. The format selected based at least in part on the level of detail sought by the given user may comprise one of a set of two or more different formats having different associated complexities.

Currently, various types of content (e.g., educational, marketing, white papers, research topics, product portfolios, sales materials, study materials, etc.) include information that has been collected and written by a team of subject matter experts (SMEs). When a researcher or other user searches the content for a topic of interest, all the material is provided to the user, who will thereafter make the content their own (e.g., for their own target audience, for their own purpose, etc.).

When information is created, it can take a considerable time in composing associated content which is a big investment in time, resources, effort, etc. Similarly, reading or understanding content may be a huge investment in time, resources, effort, etc. However, many times it happens that a given user does not like or need all of the information in the content. The given user may instead need only specific information or portions of the content, where such specific information or portions of the content may be based on the perception of the given user. Thus, only a particular subset of the information which is collected may be selected by the given user, with the rest being discarded. The particular subset of information may be based at least in part on the orientation, role, technical skills, emotional profile and observation semantics of the given user.

In a digital book, when a given user is searching for a given topic of interest, the content may be returned as a “book,” “storyline” or “presentation” that incorporates or takes into account: (i) the given user's inclination, line of orientation and/or persona (e.g., sales focused, detail oriented, sales pitch, competitive content, content which is tailor-made for a specific customer who has certain queries, etc.); (ii) the need of the hour (e.g., the current need) of the given user; and (iii) a certain level of information which is relevant to the given user based on the given user's orientation and observable skills.

Many times in customer conversations, it may take multiple sessions (e.g., 3-4 sessions) for both parties (e.g., an enterprise and its customer) to come to a common understanding. Not having the common understanding forces the enterprise (e.g., a sales team thereof) to present a generic session and move into a probing mode. On the other hand, these delays lead to customer satisfaction issues (e.g., hitting the product Net Promoter Score (NPS)). For example, a student at a university may look for books and references to gather information based on a subject that the student is interested in, and which is needed to make the student knowledgeable about that subject. The student may go through various books, class notes and other content. In the end, the information is fed into a system based on the technical orientation and skillsets of the student (e.g., such as in a notebook of the student). The use of a “digital book” can simplify the task of a student studying, through condensing content into simple and brief information based on the perception of the student.

Various situations may define the need of the hour (e.g., the current need) of the given user. Consider, for example, a situation where the given user is searching for words including “nk.” One word including “nk” is plank, which may refer to timber in the context where the given user is helping their daughter or may refer to an exercise in the context where the given user is checking their weight. Thus, depending on the context, the same words or phrases may be associated with different needs.

As another example, consider a situation where the given user is helping their daughter with a homework assignment and is searching for a species of fish. Based on the age of the given user's daughter, the current need may differ. If the daughter is 6 years old, the information should be a simplistic level (e.g., colorful and cute fishes). If the daughter is 14 years old, the information should be an intermediate level (e.g., more informative and diversified, talking about the lifecycle, eating habits and regions where different fish are found). At the intermediate level, the given user may be looking (in terms of complexity level) for videos that give information about variations in shark species and the regions in which they are found. Some of the videos may have video age ratings related to viewing the content. So, if the given user's daughter is 14 years old and in a cooking class, the given user may want to look at different varieties of edible fish which can be cooked. Videos which may be provided as results should be contextualized in terms of their region (e.g., from where they belong), availability, and the season (e.g., summer, winter, etc.).

As a further example, consider a situation where the given user is searching for information related to microservices architectures (e.g., a search query of “What is microservices architecture?”). If the given user is an application architect for an enterprise application, the given user may need to look at examples which use Postgres, with a back-end tech stack utilizing Node.js and a front-end tech stack utilizing React.js. In this context, results may be returned based on these requirements and may talk about the benefits, challenges and implementation guidelines for such different technologies and frameworks along with timelines for implementation. If the given user is an application architect for microservices, the given user may be looking for how to segregate dependencies and make an application scalable. If the given user is an enterprise architect for an enterprise, the given user may look at current cloud infrastructure spaces, network demilitarized zones (DMZ), whether cloud infrastructure is public/intranet, authentication type, concurrency of users and region availability, etc. In this context, results may be returned based on the above requirements and may talk about Pivotal Cloud Foundry (PCF), Ping Single Sign-on (SSO), Postgres, data center enablement, etc.

As another example, consider a situation where the given user is searching for information related to bears (e.g., a search query of “What are the different types of bear?”). The given user may look at content which could give them comparative information, which is very brief in terms of gaining knowledge. If the need of the hour for the given user is to know about types of bears, the results may include information related to different species of bears and where their habitats are. If the results intrigue the given user, the given user may like additional information such as results relating to the eating habits, lifecycle and benefits to different ecosystems.

As a further example, consider a situation where the given user is searching for information related to application programming interface (API) builder tools (e.g., a search query of “What is the benefit of using an API builder tool?). If the given user is an architect for a project, the given user may like to sum up the idea with the benefits, how much time is saved if the tool is used, whether the tool is platform-agnostic, how the tool contributes to deliverables for business development teams, etc. If the given user is a developer who would be using the tool for integration, the given user may need to ask certain questions (e.g., How many hops would there be?, Is there any downtime in the tool how do we get the API to work?, Can I edit the open source code?, etc.).

In some embodiments, the “need of the hour” of the given user may be learned or identified through intelligently prompting the given user to ask additional questions or revise search queries.

Illustrative embodiments provide technical solutions for understanding user context, classifying search results based on the user context, filtering the most relevant search results, and articulating the most relevant search results together into a storyline or other type of digital book based on the level of detail needed.

To understand a user's areas of interest and the potential scope of content related to such areas of interest, various elements may be determined including a persona or role of the user, and an inclination of the user. The persona or role of the user enables the search results to be categorized differently. For example, a marketing user may be interested in competitive features of products, an architect user may be interested in the technology underneath products (e.g., including scalability, performance, etc.), a security user would be looking at content that is more focused on security-related aspects, a sales user may look at the business needs of customers and competitive pricing, etc. The inclination of the user may be based on the type of content that the user reads and browses (e.g., emails, newsletters, web topics, books, movies, etc.). A machine learning model may be used to classify the inclination of the user. The inclination may be related to what topics the user is interested in, such as scientific topics, optimizations, technology pursuits, mathematical figures/graphs, etc. The inclination may also or alternatively be related to the types of content that the user is interested in, such as pictures, reading material, videos, “deep dive” analysis, etc. The inclination of the user may be learned through monitoring user click-through of different topics and/or types of content. The inclination of the user may also expand to areas such as philanthropy, historical interests, charitable giving, etc. The inclination of the user may be used to tailor the content according to the topics of interest and the need of the hour.

To understand the current context of the user, various elements may be determined (e.g., collected and monitored for) periodically, including recently performed operations or searches, the need of the hour, etc. The recently performed operations or searches indicate the user's areas or topics of interest. For example, if the user is searching for gyms, then the immediate context may be that the user is interested in health-related activities. Activity on the user's customer premises equipment (e.g., smartphone, laptop, etc.) is monitored for the recency of activity, and may be used to derive the topics or areas of interest connected to the user. The technical solutions may use this context to prioritize search results related to such derived topics or areas of interest which are connected to the user. Such prioritization may include moving such results “higher” than those relating to other topics, filtering out or otherwise removing results unrelated to the derived topics or areas of interest which are connected to the user, etc. The need of the hour is knowledge that may be kept temporarily (e.g., for a few hours), since otherwise it may result in an annoying experience for the user. Alternatively, the changes in the topics or areas of interest of the user may be monitored and, when there is a change, a determination may be made that the user has lost interest in one or more of topics or areas of interest and has gained interest in one or more other topics or areas of interest. The speed in which the user is shifting through results to get knowledge about the content could explain the level of urgency, and may indicate that the currently classified topics or areas of interest should be refined or changed.

The technical solutions may also be configured to determine whether a storyline or other type of digital book is required or desired. When a user is searching for a given topic or area of interest, various elements may be collected such as the level of detail needed (e.g., whether the user is looking for a detailed presentation, highlights, etc.). Typically, a topic that matches the inclination of the user would require details whereas other topics do not. When a user receives an email or other message with an expectation that a presentation or customer discussion is required, the process may kick in and various aspects may be collected including the level of detail needed and the inclination of the target customer. In this case, the level of detail needed may be based on whether the target customer is looking for a detailed presentation, highlights, etc. This may be determined or provided via the context of the email or other message/search topic. In this case, the inclination of the target customer and topics of interest may be derived from questions that the target customer has asked during this opportunity, or from prior experience with the target customer. This helps tune the topics and focus to given areas of interest of the target customer, like security, performance, power, features, cost considerations, etc.

The system may utilize such knowledge to conduct one or more searches on the topics of interest. From this, the system will start applying the persona and inclination of the user (or target customer) to the search results in order classify them (e.g., based on their relevance to the topics of interest). The level of detail also determines the context, such as whether the content can be summarized into a few bullet points, provided as a detailed presentation or other content, etc. From these topics of high relevance, duplicate entries/content may be removed and whatever is remaining may be provided to the user (e.g., as a summary of documents or a compilation) for approval. The final approved/modified content may be converted into a digital book, a document, a presentation with figures and tables embedded therein, etc.

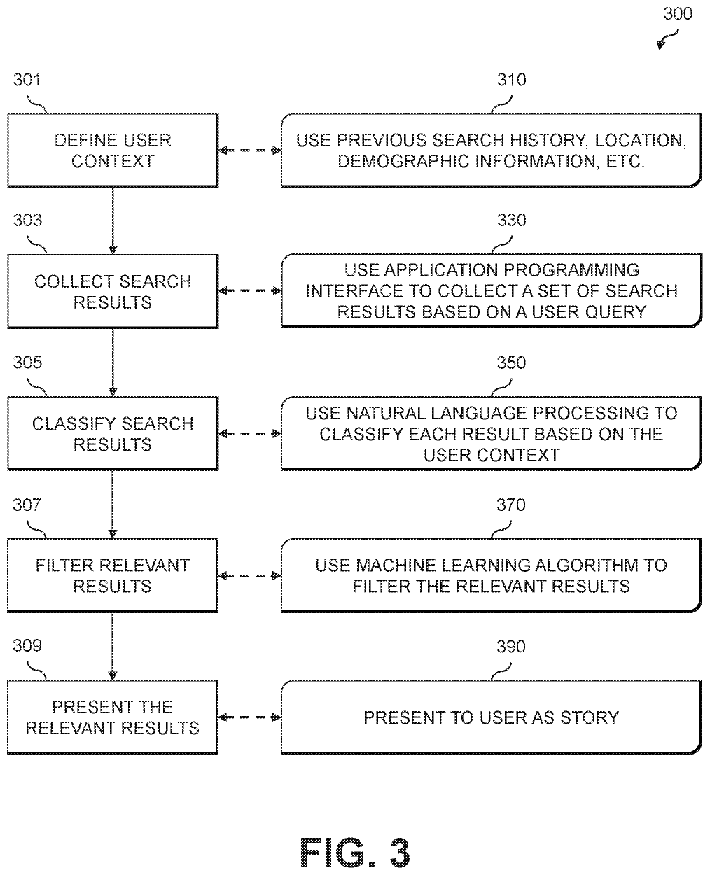

FIG. 3 shows a system flow 300 for generating responses to search queries based on context of users associated with the search queries, which includes collecting user feedback and otherwise monitoring the user to refine results which are presented to a user. The system flow 300 includes steps of defining the user context 301, collecting search results 303, classifying the search results 305, filtering the search results for relevancy 307, and presenting the relevant results 309. Defining the user context in step 301 utilizes various information 310, including the user's previous search history, location, demographic information, etc. Collecting the search results in step 303 may use an API 330 to collect a set of search results based on user queries. Classifying the search results in step 305 may use natural language processing (NLP) 350 to classify each result based on the defined user context. Filtering the relevant results in step 307 may use one or more machine learning algorithms 370 to filter the relevant results. Presenting the relevant results in step 309 may include presenting the relevant results to the user as a story line or other type or portion of a digital book 390.

The system flow 300 may create a knowledge base as a central repository of information that is used to retrieve data and provide relevant search results to the user. Creating the knowledge base may involve identifying the scope and domain of the knowledge base, collecting relevant data from various sources, organizing the data in a way that makes it easy to search and retrieve, storing the data in a secure and scalable manner, updating the data on a regular basis to keep it current and relevant, and testing and refining the knowledge base to ensure that it is providing accurate and relevant search results. The specific data present in the knowledge base would depend on the domain and scope of the system, and may include structured data, unstructured data, semantic data, and external data sources. The structured data may include data in structured formats, such as databases, spreadsheets, extensible markup language (XML) files, etc. The structured data may include, but is not limited to, product catalogs, customer data, financial data, etc. The unstructured data may include data in unstructured formats such as text, images, videos or audio. The unstructured data may include, but is not limited to, news articles, social media posts, customer reviews, etc. The semantic data may include data that is structured in a way that is machine-readable and can be used to infer relationships and connections between different pieces of information. The semantic data may include, but is not limited to, ontologies, taxonomies, etc. The external data sources may include public APIs, web scraping tools, data feeds, etc., which can provide additional sources of information.

The knowledge base may provide an important component in some embodiments, as it provides the raw data that the system can use to understand user queries and provide relevant search results. The specific data present in the knowledge base would depend on the specific use case and requirements of the system. The various steps of the system flow 300 will now be described in further detail.

Defining the user context in step 301 includes determining the specific context of a user's search query (e.g., based on the information 310 including the user's previous search history, location, demographic information and other factors). Defining the user context may be a critical part of the solution, and involves analyzing the user's search query. The user's search query provides valuable information about the user's context. Analyzing keywords and phrases in the search query can provide insights into the user's intent and context. A user profile includes information about the user's demographics, location, search history and other data that can help define the user's context. For example, if the user is located in a certain city, the search results can be tailored to that location. The user's behavior (e.g., on a website or platform) can also provide valuable information about their context. For example, if the user has visited certain pages or clicked on certain links, this can help define their context and tailor the search results accordingly. NLP techniques can help understand the user's context by analyzing the text input by the user. This may include analyzing the syntax, semantics and context of the user's text input. Machine learning algorithms can be used to analyze the user's behavior and past interactions with a website or platform to determine their context. This includes analyzing past searches, click-through rates, and engagement metrics to provide relevant search results.

Collecting search results in step 303 may use the API 330, which may include or utilize one or more search engines, to collect a set of search results based on the user's query. Collecting the search results involves the process of retrieving a set of web pages or other online content that are relevant to a user's search query. First, a search engine may be chosen to use to collect search results. This could be a search engine from Google, Bing. Yahoo, etc. A search query is then constructed based on the user's input. This includes analyzing the user's query to determine the most relevant keywords or phrases to use in the search query. The constructed search query is then sent to the selected API 330. This can be achieved using a Hypertext Transfer Protocol (HTTP) request to the API 330, with the search query as a parameter of the HTTP request. The API 330 will return a set of search results. These results may include a list of uniform resource locators (URLs), titles, descriptions, and other collected metadata. The collected results are then processed to extract relevant information, such as the page title, description, URL, etc. This may involve using web scraping tools or parsing the HTML of the search results page. The processed search results are then stored in a database or other data structure for further analysis and processing. Error handling is also performed, including handling any errors or exceptions that may occur during the search results collection process (e.g., such as network errors, invalid search queries, etc.).

Classifying the search results in step 305 uses NLP 350 techniques to classify each search result based on the user's context. This may involve analyzing the keywords, topics and entities in each search result and comparing them to the user's context through defining categories, analyzing the search results, assigning categories to the search results, and refining the classifications. Categories are defined which will be used to classify the search results. These categories should be based on the user's context and the nature of the search query. For example, if the user is searching for information about a product, the categories could include price, specifications, reviews, availability, etc. The search results are then analyzed to determine which categories they belong to. This may involve or utilize NLP techniques that identify relevant keywords or phrases in the search results. Once the relevant keywords or phrases are identified, the search results are assigned to the appropriate categories. This may involve creating a mapping between the keywords and the categories, using one or more machine learning algorithms to automatically classify the search results, etc. The classification may then be refined based on user feedback, additional analysis, etc. For example, if a user frequently searches for a particular category, that category may be prioritized in the search results.

Filtering the relevant search results in step 307 may use machine learning algorithms 370 to filter the most relevant search results based on the user's context. This may involve training one or more machine learning models on a labeled dataset of relevant and irrelevant search results, and using the trained machine learning models to predict the relevance of new search results. This may include defining criteria, analyzing the search results, assigning scores to the search results, and sorting the search results based on the assigned scores. The criteria to be used in filtering the search results may be defined based on the user's context and the nature of the search query. For example, if the user is searching for a specific product, the criteria could include price, availability, customer ratings, etc. The search results are analyzed to determine which ones meet the defined criteria. This may involve use of NLP techniques to identify relevant keywords or phrases in the search results, using machine learning algorithms 370 to automatically classify the search results, etc. Once the relevant search results are identified, they may be assigned scores based on how well they meet the defined criteria. This may involve assigning a numerical score to each search result based on the defined criteria, or using more complex algorithms to calculate relevance scores. The search results are then sorted based on their relevance scores such that the most relevant search results are listed first. This could involve sorting the search results in ascending or descending order based on the relevance scores.

Presenting the relevant search results in step 309 includes presenting the filtered, relevant search results to the user in a user-friendly interface (e.g., a list, a summary, etc.). The user-friendly way that the relevant search results are presented may be based on user preferences (e.g., grid, list card, etc.). In some embodiments, the system flow 300 may be continuously improved by monitoring and evaluating the system's performance and collecting user feedback in order to improve accuracy and effectiveness.

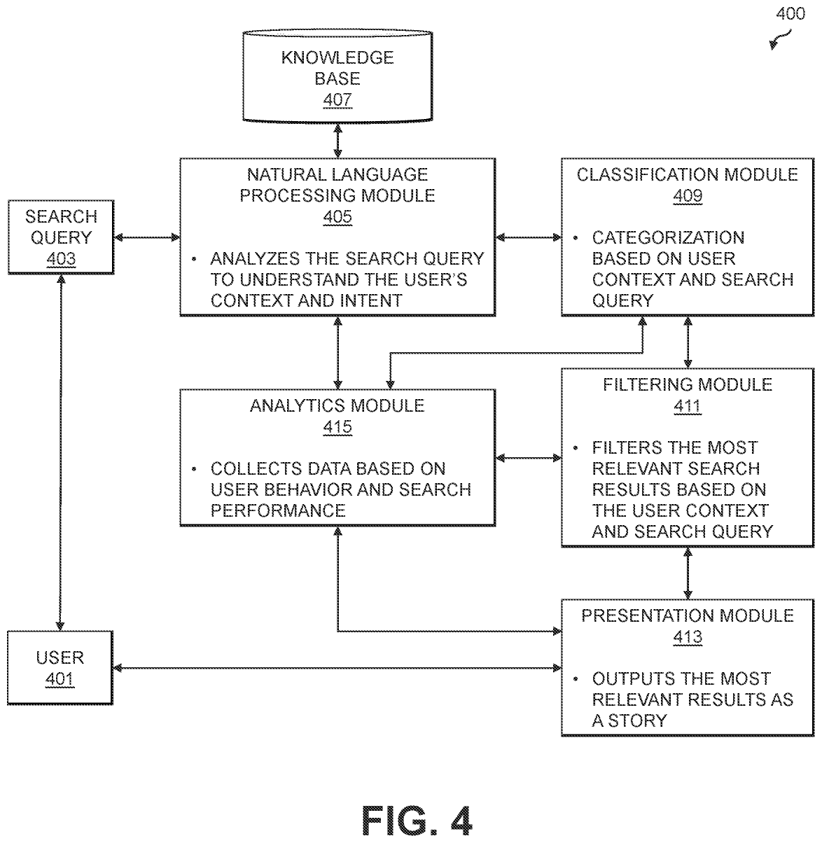

FIG. 4 shows a system 400 which may be used to implement the system flow 300 of FIG. 3. The system 400 includes a user 401 which submits a search query 403, with the search query 403 being passed to an NLP module 405 that analyzes the search query 403 to understand the user's context and intent. The NLP module 405 may utilize various information from a knowledge base 407, constructed as described above. After processing in the NLP module 405, a classification module 409 performs categorization based on the user context (determined utilizing the NLP module 405) and the search query 403. A filtering module 411 then filters the most relevant search results based on the user context and the search query 403, where the filtering utilizes the categorizations determined utilizing the classification module 409. A presentation module 413 then outputs to the user 401 (e.g., via a graphical user interface (GUI)) the most relevant search results (determined utilizing the filtering module 411) as a “story” in a digital book or other desired format. The user 401 can interact with the search results (e.g., the story presented via the GUI) to provide feedback on their relevance. An analytics module 415 may collect data based on user behavior and search system performance, and uses the collected data to update and refine processing in other elements of the system 400 including the NLP module 405, the knowledge base 407, the classification module 409, the filtering module 411 and the presentation module 413.

The technical solutions described herein provide various technical advantages, including in personalization, integration with multiple data sources, adaptive algorithms, and rich media support. By understanding the user's context and behavior, the technical solutions described herein can provide personalized search results and recommendations that are tailored to the user's specific needs and preferences. This can improve the user experience and increase the relevance of search results. The technical solutions described herein can integrate with multiple data sources, such as public databases, social media platforms, and private enterprise data, to provide a comprehensive set of search results. The technical solutions described herein can further use adaptive algorithms that learn from user behavior and feedback, and continuously improve the relevance and accuracy of search results over time. The technical solutions described herein can support rich media such as images, video and audio, in addition to text-based search results, to provide a more immersive and engaging search experience.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for generating responses to search queries based on context of users associated with the search queries will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100 in FIG. 1. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. A hypervisor platform may be used to implement a hypervisor within the virtualization infrastructure 504, where the hypervisor platform has an associated virtual infrastructure management system. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for generating responses to search queries based on context of users associated with the search queries as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. An apparatus comprising:
at least one processing device comprising a processor coupled to a memory;
the at least one processing device being configured:
to receive a search query associated with a given user;
to determine a user context associated with the given user, the user context specifying (i) one or more topics of interest of the given user and (ii) a level of detail sought by the given user, the user context being determined based at least in part on the received search query and monitoring interaction of the given user with at least one user interface at which the search query is received and at which one or more previous search responses generated for the given user are provided;
to determine a set of one or more keywords and phrases based at least in part on analyzing syntax and semantics of the received search query using the determined user context;
to generate a constructed search query based at least in part on the determined set of one or more keywords and phrases;
to execute the constructed search query to obtain one or more search results;
to apply natural language processing to the one or more search results to assign, to each of the one or more search results, at least one classification of a set of two or more classifications, the set of two or more classifications being defined based at least in part on the one or more topics of interest specified in the determined user context;
to utilize one or more machine learning models to filter the one or more search results for relevancy to the given user, the relevancy being determined based at least in part on the classifications assigned to each of the one or more search results;
to select, from a set of two or more different formats having different associated complexities, a given format for a search response to the received search query based at least in part on the level of detail sought by the given user;
to generate the search response to the received search query based at least in part on the filtering and the selected format; and
to provide the generated search response to the given user in the selected format.

2. The apparatus of claim 1 wherein determining the user context comprises identifying the one or more topics of interest of the given user based at least in part on a user profile of the given user.

3. The apparatus of claim 2 wherein the user profile of the given user specifies at least one of demographic information associated with the given user, a location of the given user, and a search history of the given user.

4. The apparatus of claim 1 wherein determining the user context comprises identifying the one or more topics of interest of the given user based at least in part on user behavior of the given user.

5. The apparatus of claim 4 wherein the user behavior of the given user is determined based at least in part on analyzing interaction of the given user with the at least one user interface.

6. The apparatus of claim 1 wherein determining the user context comprises identifying the one or more topics of interest of the given user based at least in part on applying natural language processing to the text of the search query, the natural language processing comprising analyzing the syntax, the semantics and context of the text of the search query.

7. The apparatus of claim 1 wherein determining the user context is based at least in part on identifying a role of the given user within an enterprise.

8. The apparatus of claim 1 wherein determining the user context is based at least in part on identifying an inclination of the given user.

9. The apparatus of claim 8 wherein the inclination of the given user is determined based at least in part on one or more types of content consumed by the given user.

10. The apparatus of claim 1 wherein determining the user context is based at least in part on recency of activity of the given user.

11. The apparatus of claim 1 wherein the given user comprises a target customer of an enterprise, and wherein the user context is determined based at least in part on past interactions between the target customer and the enterprise.

12. The apparatus of claim 1 wherein applying the natural language processing to the one or more search results comprises identifying one or more keywords in the one or more search results, and mapping the identified one or more keywords to respective ones of the classifications in the set of two or more classifications.

13. The apparatus of claim 1 wherein utilizing the one or more machine learning models to filter the one or more search results for relevancy to the given user comprises generating, utilizing the one or more machine learning models, relevancy scores for the one or more search results.

14. The apparatus of claim 1 wherein the format selected based at least in part on the level of detail sought by the given user comprises one of a set of two or more different formats having different associated complexities.

15. A computer program product comprising a non-transitory processor-readable storage medium having stored therein program code of one or more software programs, wherein the program code when executed by at least one processing device causes the at least one processing device:
to receive a search query associated with a given user;
to determine a user context associated with the given user, the user context specifying (i) one or more topics of interest of the given user and (ii) a level of detail sought by the given user, the user context being determined based at least in part on the received search query and monitoring interaction of the given user with at least one user interface at which the search query is received and at which one or more previous search responses generated for the given user are provided;
to determine a set of one or more keywords and phrases based at least in part on analyzing syntax and semantics of text of the received search query using the determined user context;
to generate a constructed search query based at least in part on the determined set of one or more keywords and phrases;
to execute the constructed search query to obtain one or more search results;
to apply natural language processing to the one or more search results to assign, to each of the one or more search results, at least one classification of a set of two or more classifications, the set of two or more classifications being defined based at least in part on the one or more topics of interest specified in the determined user context;
to utilize one or more machine learning models to filter the one or more search results for relevancy to the given user, the relevancy being determined based at least in part on the classifications assigned to each of the one or more search results;
to select, from a set of two or more different formats having different associated complexities, a given format for a search response to the received search query based at least in part on the level of detail sought by the given user;
to generate the search response to the received search query based at least in part on the filtering and the selected format; and
to provide the generated search response to the given user in the selected format.

16. The computer program product of claim 15 wherein determining the user context is based at least in part on identifying a role of the given user within an enterprise.

17. The computer program product of claim 15 wherein determining the user context is based at least in part on identifying an inclination of the given user, the inclination of the given user being determined based at least in part on one or more types of content consumed by the given user.

18. A method comprising:
receiving a search query associated with a given user;
determining a user context associated with the given user, the user context specifying (i) one or more topics of interest of the given user and (ii) a level of detail sought by the given user the user context being determined based at least in part on the received search query and monitoring interaction of the given user with at least one user interface at which the search query is received and at which one or more previous search responses generated for the given user are provided;
determining a set of one or more keywords and phrases based at least in part on analyzing syntax and semantics of text of the received search query using the determined user context;
generating a constructed search query based at least in part on the determined set of one or more keywords and phrases;
executing the constructed search query to obtain one or more search results;
applying natural language processing to the one or more search results to assign, to each of the one or more search results, at least one classification of a set of two or more classifications, the set of two or more classifications being defined based at least in part on the one or more topics of interest specified in the determined user context;
utilizing one or more machine learning models to filter the one or more search results for relevancy to the given user, the relevancy being determined based at least in part on the classifications assigned to each of the one or more search results;
selecting, from a set of two or more different formats having different associated complexities, a given format for a search response to the received search query based at least in part on the level of detail sought by the given user;
generating the search response to the received search query based at least in part on the filtering and the selected format; and
providing the generated search response to the given user in the selected format;
wherein the method is performed by at least one processing device comprising a processor coupled to a memory.

19. The method of claim 18 wherein determining the user context is based at least in part on identifying a role of the given user within an enterprise.

20. The method of claim 18 wherein determining the user context is based at least in part on identifying an inclination of the given user, the inclination of the given user being determined based at least in part on one or more types of content consumed by the given user.
